(19) United States
(12) Patent Application Publication
(10) Pub. No.: US 2011/0206361 A1
(43) Pub. Date: Aug. 25, 2011

(54) IMAGE TAKING DEVICE AND IMAGE TAKING METHOD

(75) Inventor: Takashi IWAMOTO, Urayasu-shi (JP)

(73) Assignee: Empire Technology Development LLC, Wilmington, DE (US)

(21) Appl. No.: 12/955,728

(22) Filed: Nov. 29, 2010

(30) Foreign Application Priority Data
Feb. 22, 2010 (JP) 2010-036240

(51) Int. Cl. G03B 17/00

(52) U.S. Cl. 396/263

(57) ABSTRACT

An image taking device and an image taking method are provided. The image taking device and image taking method allow a shutter to be released without having to apply much force while preventing camera shake that can occur during image taking of a subject and while preventing unintended release of the shutter.

### CROSS-REFERENCE TO RELATED APPLICATIONS

This application claims priority to Japanese Patent Application No. 2010-036240, filed Feb. 22, 2010, which is hereby incorporated herein by reference.

### TECHNICAL FIELD

Embodiments of the disclosure relate to an image taking device that has a shutter and takes an image by opening and closing the shutter, and an image taking method.

### BACKGROUND

Cameras are used as an image capturing device for taking still images of a subject. With a general conventional camera, a user presses a shutter button in order to take a still image of a subject. Completely pressing the shutter button requires the user to exert a certain amount of force. However, fully pressing the shutter button without moving the camera is difficult and often causes camera shake, which results in blurring of the still image.

One way to take a clear still image without blurring the still image is to fix a camera on a tripod and take a picture without directly pressing the shutter button. The picture can be taken, for example, by connecting a release to the shutter button and manipulating the release to operate the shutter.

More recently, digital cameras have been introduced that have a touch-sensitive panel or touch pad on the camera. These digital cameras provide shutter button functions at a desired position on the panel or pad so that the user can release the shutter to take an image by touching the position on the panel without using much force.

For these digital cameras with a touch-sensitive-panel shutter button, methods have been disclosed for taking an image that is unaffected by camera shake. The image is taken by touching the touch-sensitive-panel shutter button. The shutter can also be released when the user's finger has moved away from the touch-sensitive-panel shutter button.

However, since a camera shutter button that functions at a certain position on a touch-sensitive panel or touch pad allows the shutter to be released just by touching the position without applying much force, the camera can accidentally release the shutter when something makes contact with the position. For example, the shutter may be accidentally released when the user carries the camera in a pocket or a bag.

A camera that releases the shutter when the user's finger has moved away from the shutter button can also accidentally release the shutter when something comes into and out of contact with the shutter-button position.

Therefore, it is desirable to have an image taking device and an image taking method for allowing a shutter to be released without having to apply much force while preventing camera shake that can occur during shooting of a subject and while preventing unintended release of the shutter.

### SUMMARY

An image taking device according to the present disclosure includes: a housing; a shutter contained in the housing; an imaging unit that is contained in the housing and that receives incident light upon opening of the shutter to form an image of a subject; an operation unit that is provided on the housing for performing opening and closing operations of the shutter; and a touch-sensitive panel provided on a first surface of the housing. The operation unit includes a first touch sensor and a second touch sensor that can be touched by a user when the user holds the housing. The operation unit can open and close the shutter after both the first touch sensor has detected a contact and the second touch sensor has detected a contact within a predetermined time period after the contact detected by the first touch sensor. A predetermined portion or area of the touch-sensitive panel functions as the first touch sensor and the second touch sensor may be provided on a second surface of the housing that is different from the first surface.

Also, an image taking device according to the present disclosure includes a housing; a shutter contained in the housing; an imaging unit that is contained in the housing and that receives incident light upon opening of the shutter to form an image of a subject; and an operation unit that is provided on the housing for performing opening and closing operations of the shutter. The operation unit has a first touch sensor and a second touch sensor that can be touched by a user when the user holds the housing. The operation unit opens and closes the shutter after the first touch sensor has detected a contact and the second touch sensor has detected a contact within a predetermined time period after the contact detected by the first touch sensor.

The operation unit of the image taking device may open and close the shutter after the first touch sensor has detected a release of the contact and the second touch sensor has detected a contact within a predetermined time period after the release of the contact of the first touch sensor.

The operation unit of the image taking device may open and close the shutter after the second touch sensor has detected a contact while a contact is being detected by the first touch sensor.

The operation unit of the image taking device may open and close the shutter after the second touch sensor has detected the release of the contact of the first touch sensor and the second touch sensor has detected a contact within a predetermined time period after the release of the contact.

The operation unit of the image taking device may, when detecting that the second touch sensor has been touched for at least a predetermined time period, open and close the shutter at predetermined time intervals until the contact is released.

The operation unit of the image taking device may open and close the shutter when the second touch sensor has detected a contact.

The operation unit of the image taking device may open and close the shutter when the second touch sensor has detected a release of the contact.

The image taking device may have a configuration in which the first touch sensor is positioned on a first surface of the housing, and the second touch sensor is positioned on a second surface of the housing that is different from the first surface.

The image taking device may further include a touch-sensitive panel provided on the housing, and a portion of the touch-sensitive panel may function as at least one of the first and second touch sensors. In this configuration, the portion or area of the touch-sensitive panel that functions as at least one of the first and second touch sensors may be arbitrarily configurable by the user.

The image taking device according to the present disclosure may further include a touch-sensitive panel provided on the housing. Predetermined areas of the touch-sensitive panel separated by space respectively function as the first and second touch sensors. In this configuration, the predetermined areas of the touch-sensitive panel are arbitrarily configurable by the user.

The imaging unit of the image taking device may have auto-focusing function and determine a focal length when the first touch sensor has detected a contact.

The operation unit may have a control unit to perform fingerprint authentication. The control unit may be configured to determine that the first touch sensor has detected a contact when the control unit determines that fingerprint authentication is successful based on a signal that is output when the first touch sensor has detected a contact.

The image taking device may have two of the first touch sensors, and the two first touch sensors may be provided at positions on the touch-sensitive panel separated by space. The operation unit may open and close the shutter after the two first touch sensors have detected a contact and the second touch sensor has detected a contact within a predetermined time period after the contact detected by the two first touch sensors.

A portable terminal according to the present disclosure may include the aforementioned image taking device according to the present disclosure, and a data communication function to perform data communication by radio.

An image taking method according to the present disclosure includes an image taking method for taking an image of a subject by opening and closing a shutter, the method including: detecting a contact, by a first touch sensor provided on a housing of an image taking device; and detecting a contact, by a second touch sensor provided on the housing of the image taking device after the first touch sensor detected a contact. A control unit in the image taking device opens and closes the shutter after the second touch sensor has detected a contact.

### BRIEF DESCRIPTION OF THE FIGURES

FIG. 1 is a front perspective view schematically showing one illustrative example of an image taking device;

FIG. 2 is a backside perspective view schematically showing the image taking device shown in FIG. 1;

FIG. 3 is a block diagram showing an illustrative example of a functional configuration for opening and closing a shutter of the image taking device;

FIG. 4 is a flowchart of an illustrative method for opening and closing the shutter of the image taking device;

FIG. 5 is a backside perspective view schematically showing an illustrative example of an image taking device;

FIG. 6 is a front perspective view schematically showing an illustrative example of an image taking device;

FIG. 7 is a front perspective view schematically showing the image taking device of FIG. 6 in a telephone mode; and

FIG. 8 is a front perspective view schematically showing the image taking device of FIG. 6 in a camera mode.

### DETAILED DESCRIPTION

An image taking device and an image taking method according to embodiments of the present disclosure will be described with reference to the drawings. Embodiments set forth below are for describing embodiments of the present disclosure and are not intended to limit the present disclosure only to those embodiments. Therefore, the present disclosure may be practiced in any of various forms within the spirit thereof.

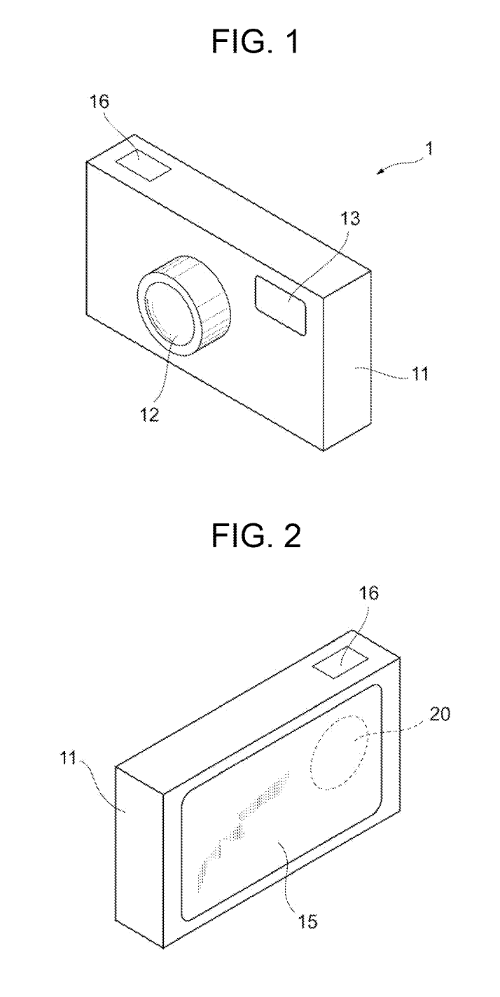

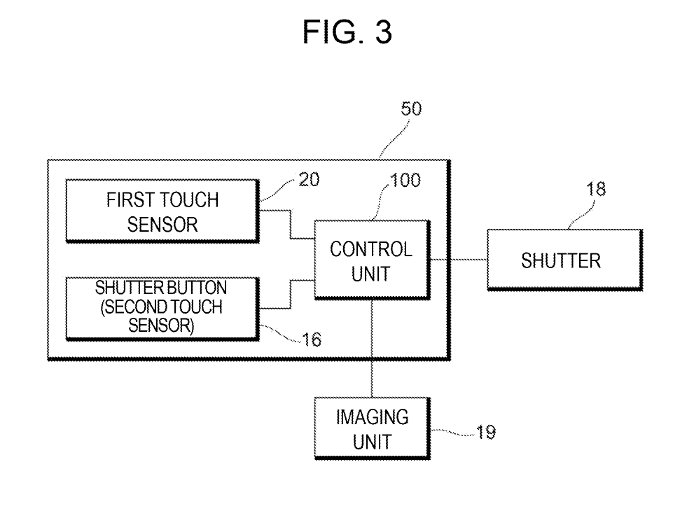

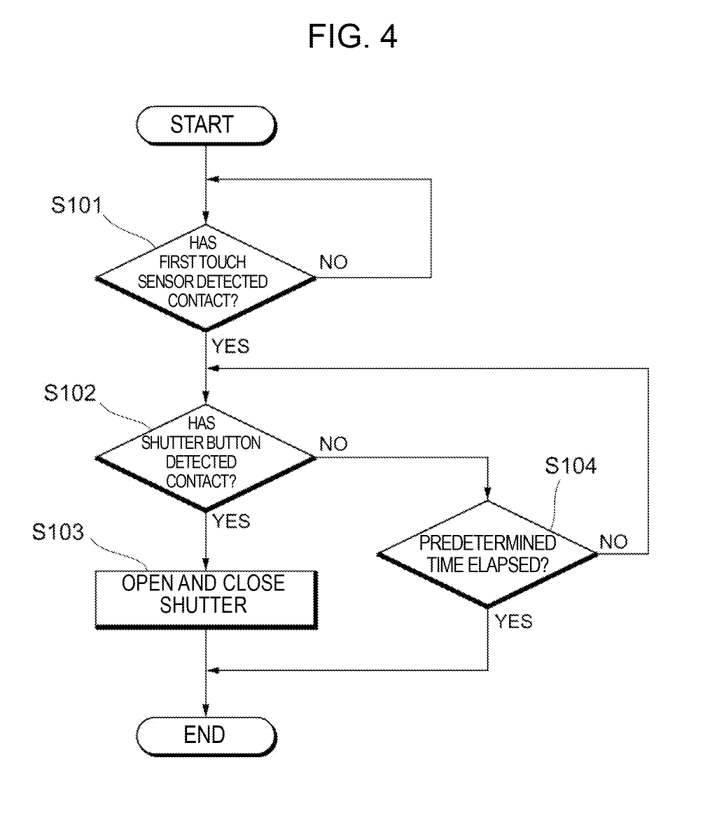

FIG. 1 is a front perspective view schematically showing an illustrative example of an image taking device; FIG. 2 is a backside perspective view schematically showing the image taking device shown in FIG. 1; FIG. 3 is a block diagram showing an illustrative example of a functional configuration for opening and closing a shutter of the image taking device; and FIG. 4 is a flowchart of an illustrative method for opening and closing the shutter of the image taking device. In the Figures, a thickness, dimension, and the like of components are not drawn to scale for the sake of clarity.

As shown in FIGS. 1 to 3, an image taking device 1 is illustrated as a digital camera. The image taking device 1 includes an image taking lens 12 and an objective-side window 13 of a finder arranged on a front surface of a housing 11 of the image taking device 1. The housing 11 contains a shutter 18, an aperture, an imaging unit 19, a control unit 100 for controlling image taking operations, and so forth. On a back surface of the housing 11, a liquid crystal display 15 is embedded. The shutter 18, aperture, imaging unit 19 and the like are similar to those of a conventional digital camera.

The liquid crystal display 15 includes a touch-sensitive panel over an entire surface thereof and functions as a finder. The liquid crystal display 15 is also used as a user interface to provide access to image data taken via the image taking lens 12 and various functions of the image taking device 1. An area (e.g., a portion of the display shown by a dotted line in FIG. 2) of the liquid crystal display 15 that can be touched by a user (e.g., a thumb of the user's right hand) when the user holds the housing 11 is configured to function as a first touch sensor 20 to detect contact when the user touches the area. The first touch sensor 20 is connected with the control unit 100 and a signal detected by the first touch sensor 20 is sent to the control unit 100.

A shutter button 16 for opening/closing the shutter is provided at a position on an upper surface of the housing 11 that can be touched by the user when the user holds the housing 11. The shutter button 16 includes a touch sensor for detecting contact when the user touches the shutter button 16. The image taking device 1 is configured to release the shutter 18 to cause light incident through the image taking lens 12 to impinge the imaging unit 19 to form an image of a subject (an optical image) by the user touching the first touch sensor 20 and then the shutter button 16 (a second touch sensor). The shutter button 16 is connected to the control unit 100 and a signal detected by the shutter button 16 is sent to the control unit 100.

According to an embodiment, the first touch sensor 20, the shutter button 16 (the second touch sensor), and the control unit 100 constitute an illustrative example of an operation unit 50 for performing opening/closing operations of the shutter 18 as shown in FIG. 3.

Specifically, releasing (or opening/closing) operations of the shutter 18 may take place as follows. For example, at step S101 of the flowchart shown in FIG. 4, the control unit 100 determines whether the first touch sensor 20 has detected a contact or not. If the first touch sensor 20 has detected a contact (YES at step S101), the method proceeds to step S102. If the first touch sensor 20 has not detected a contact (NO at step S101), the method returns to step S101.

At step S102, the control unit 100 determines whether the shutter button 16 has detected a contact or not. If the shutter button 16 has detected a contact (YES at step S102), the method proceeds to step S103. In step S103, the shutter 18 is opened and closed to take an image of the subject. On the other hand, if the shutter button 16 has not detected a contact (NO at step S102), the method proceeds to step S104.

At step S104, the control unit 100 determines whether a predetermined time period has elapsed since the first touch sensor 20 detected a contact. If the predetermined time period has elapsed (YES at step S104), the method ends. On the other hand, if the predetermined time has not elapsed (NO at step S104), the method returns to step S102.

In one embodiment, the image taking device 1 does not release the shutter 18 when only the shutter button 16 has been touched without the first touch sensor 20 being touched. In other words, both the first touch sensor 20 and the shutter button 16 are touched or at least detect a contact before the image taking device releases the shutter 18. The image taking device 1 does not release the shutter 18 as long as the shutter button 16 is not touched, even if the first touch sensor 20 is touched. This can keep the shutter 18 from being released in response to an unintended contact while the image taking device 1 is, by way of example only, in a bag or a pocket.

In an embodiment, the control unit 100 performs control functions such that the shutter 18 is opened and closed when the control unit 100 determines that the first touch sensor 20 has detected a contact and that the shutter button 16 has detected a contact. This is not limiting, however. The control unit 100 may also open and close the shutter 18 when the control unit 100 determines that the first touch sensor 20 has detected a contact and the release of the contact, and thereafter the detected a contact of the shutter button 16.

In this case, the control unit 100 may also control the shutter 18 by opening and closing the shutter 18 when the control unit 100 determines that the shutter button 16 has detected a contact within a predetermined time since when the contact detected by the first touch sensor 20 ceased.

The control unit 100 may also control the shutter 18 by opening and closing the shutter 18 when the first touch sensor 20 has detected a contact and the shutter button 16 has also detected a contact, or when both the first touch sensor 20 and the shutter button 16 have detected a contact and then the shutter button 16 has detected the release of the contact.

The control unit 100 may also control the shutter 18 by opening and closing the shutter 18 when, after the first touch sensor 20 and the shutter button 16 have detected contact, the shutter button 16 has detected a contact again within a predetermined time period since when the shutter button 16 detected the release of the first contact. In this case, continuous shooting of the subject is possible.

Furthermore, the control unit 100 may also perform control such that when the first touch sensor 20 has detected a contact and the shutter button 16 has detected a contact that lasts at least a predetermined time, the shutter 18 is opened and closed at certain time intervals until the shutter button 16 detects the release of the contact. In this case, automatic continuous shooting of the subject is possible.

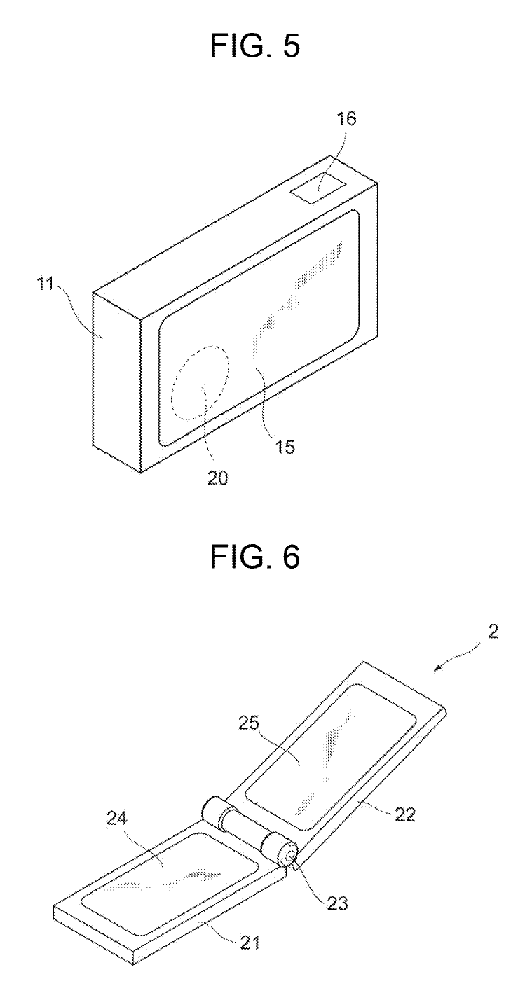

In an embodiment, an area of the liquid crystal display 15 that can be touched by the user (e.g., a thumb of the user's right hand) when the user holds the housing 11 functions as the first touch sensor 20 as described above. This is not limiting, however. FIG. 5 is a backside perspective view schematically showing an illustrative example of the image taking device 1. For example, an area of the liquid crystal display 15 that can be touched by the thumb of the user's left hand when the user holds the housing 11 may be configured to function as the first touch sensor 20 as shown in FIG. 5. A desired area of the liquid crystal display 15 can also be set to function as the first touch sensor 20 and may be user-configurable. Further, a liquid crystal display may be provided on the upper surface of the housing 11 and an area of the liquid crystal display on the upper surface that can be touched by the user may function as the shutter button 16.

Also, the image taking device 1 may have multiple first touch sensors 20. For example, the image taking device 1 may have both the first touch sensor 20 shown in FIG. 2 and the first touch sensor 20 shown in FIG. 5. The control unit 100 may control the shutter 18 by opening and closing the shutter 18 when both the first touch sensors 20 have detected a contact and also the shutter button 16 has detected a contact. In this case, the user may be required to hold the housing 11 with both hands and thus can take pictures in a stable position.

Also, the first touch sensor 20 can also be used as a trigger to start focusing. A conventional, or non-touch-sensor, shutter button is designed to focus the camera when the button is halfway pressed and release the shutter when the button is fully pressed. A touch-sensor shutter button, however, makes it difficult to distinguish between halfway pressing and full pressing. The image taking device 1 eliminates the necessity to include a separate element (a component) acting as a trigger for focusing the image taking device 1 by configuring the control unit 100 to perform control such that a focal length is determined by auto-focusing upon detection of contact by the first touch sensor 20. The shutter 18 is opened and closed following detection of contact by the shutter button 16.

Furthermore, the control unit 100 may include a fingerprint authentication unit to perform fingerprint authentication and may determine that the first touch sensor 20 has detected a contact if the control unit 100 determines that fingerprint authentication is successful based on output from the first touch sensor 20. In this case, only a particular user is allowed to take pictures. Also, by utilizing the fingerprint authentication as a condition for switching to a picture playback mode, it is also possible to prevent playback of pictures against the user's will to enhance security. The fingerprint authentication capability may also be configured to be arbitrarily enabled and disabled by the user so that a particular user can choose to permit other users to take or play back pictures.

By way of example only and not limitation, the first touch sensor 20 may be provided on the back surface of the housing 11 (i.e., the liquid crystal display 15) and the shutter button 16 may be provided on the upper surface of the housing 11. The first touch sensor 20 and the shutter button 16 may be located at any position that can be touched by the user when the user holds the housing 11. For example, any positions separated by space on the liquid crystal display 15 may have the functions of the first touch sensor 20 and the shutter button 16. Also, the first touch sensor 20 may be positioned somewhere other than the liquid crystal display 15 on the housing 11.

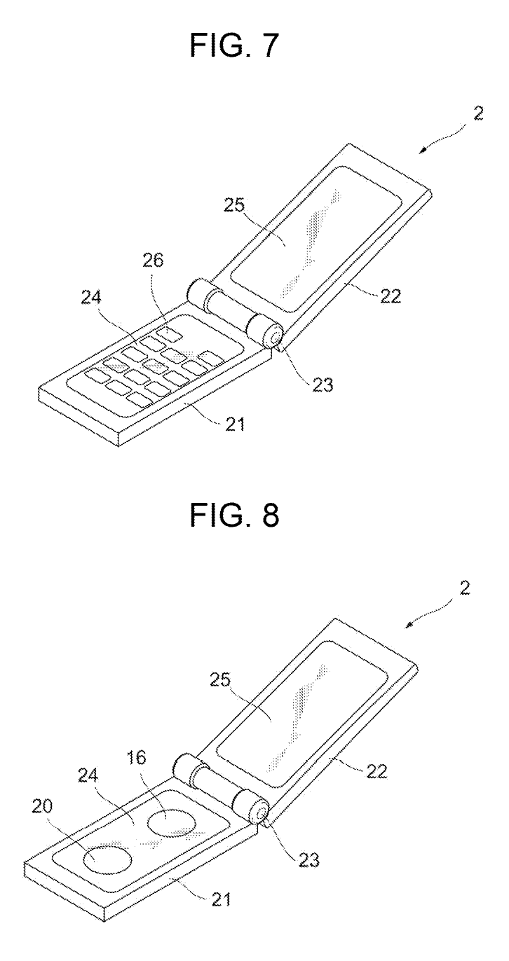

In an embodiment, a portable terminal according to the present disclosure will be described with reference to the drawings. FIG. 6 is a front perspective view schematically showing an illustrative example of an image taking device. The image taking device in FIG. 6 may be a portable terminal. FIG. 7 is a front perspective view schematically showing the portable terminal shown in FIG. 6 in a telephone mode. FIG. 8 is a front perspective view schematically showing the portable terminal shown in FIG. 6 in a camera mode. In the figures, thickness, dimension, and the like of components are not drawn to scale for the sake of clarity. Also, similar components to those of the other embodiments are given the same reference numerals and detailed descriptions of such components are omitted.

As shown in FIGS. 6 to 8, a portable terminal 2 according to an embodiment of the present disclosure includes a folding mobile phone that has camera functions and data communication functions to perform data communication by radio. The portable terminal 2 contains an image taking device having the configuration shown in FIG. 3 like the image taking device 1, and a first housing 21 and a second housing 22 are connected with each other by a hinge 23.

A liquid crystal display 24 is positioned on the first housing 21 and is formed of a touch-sensitive panel to be operated by the user. The liquid crystal display 24 is connected with a processing circuit contained in the housing 21 and displays user interface screens for various modes and functions as a user interface. For example, when the portable terminal 2 is in the telephone mode, a character/numeric key area 26 is displayed on the liquid crystal display 24 as shown in FIG. 7, allowing the user to enter a telephone number or mail text by operating the character/numeric key area 26 as with a conventional mobile phone.

When the portable terminal 2 is in the camera mode, an area of the liquid crystal display 24 that can be touched by the user (e.g., the thumb of the user's right of left hand) when the user holds the first housing 21 functions as the first touch sensor 20 to detect a contact when the user touches the area as shown in FIG. 8. Another area of the liquid crystal display 24 that can be touched by the thumb of the other hand when the user holds the first housing 21 functions as the shutter button 16. The first touch sensor 20 and the shutter button 16 are connected with the control unit 100, and signals detected by the first touch sensor 20 and the shutter button 16 are sent to the control unit 100. In this embodiment, the control unit 100 may be a part of a processing circuit contained in the first housing 21.

On the second housing 22, a liquid crystal display 25 is positioned. An image taking lens is embedded in an opposite side of the surface of the second housing 22 on which the liquid crystal display 25 is positioned and the liquid crystal display 25 serves as a finder. The second housing 22 contains a shutter, an aperture, an imaging unit, and the like.

The user can take a picture of a subject with the portable terminal 2 by first switching the portable terminal 2 to the camera mode, holding the first housing 21, touching the first touch sensor 20 with the thumb of one hand (or other finger) and then the shutter button 16 with the thumb or finger of the other hand.

The image taking device included in the portable terminal 2 does not open and close the shutter when the shutter button 16 has detected a contact without the first touch sensor 20 also detecting a contact, and the image taking device included in the portable terminal 2 does not open and close the shutter either even if the first touch sensor 20 has detected a contact but the shutter button 16 has not detected a contact, similar to the image taking device 1. This can prevent the shutter from being released in response to an accidental contact when the portable terminal 2 is carried in a bag or a pocket, for example. The portable terminal 2 also has the focusing and fingerprint authentication functions described herein.

For the image taking device included in the portable terminal 2, the first touch sensor 20 and the shutter button 16 may be set at any positions that can be touched by the user when the user holds the first housing 21 or the second housing 22, similar to the image taking device 1 previously described.

What is claimed is:

1. An image taking device comprising:
a housing;
a shutter contained in the housing;
an imaging unit that is contained in the housing and that receives incident light upon opening of the shutter to form an image of a subject;
an operation unit that is provided on the housing, the operation unit for performing opening and closing operations of the shutter; and
a touch-sensitive panel provided on a first surface of the housing, wherein:
the operation unit has a first touch sensor and a second touch sensor that can be touched by a user when the user holds the housing;
the operation unit opens and closes the shutter after both the first touch sensor has detected a first contact and the second touch sensor has detected a second contact within a predetermined time period after the first contact detected by the first touch sensor;
a predetermined area of the touch-sensitive panel functions as the first touch sensor; and
the second touch sensor is provided on a second surface of the housing that is different from the first surface.

2. An image taking device comprising:
a housing;
a shutter contained in the housing;
an imaging unit that is contained in the housing and that receives incident light upon opening of the shutter to form an image of a subject; and
an operation unit that is provided on the housing, the operation unit for performing opening and closing operations of the shutter, wherein:
the operation unit has a first touch sensor and a second touch sensor that can be touched by a user when the user holds the housing; and
the operation unit opens and closes the shutter after both the first touch sensor has detected a first contact and the second touch sensor has detected a second contact within a predetermined time period after the first contact detected by the first touch sensor.

3. The image taking device according to claim 2, wherein the operation unit opens and closes the shutter after the first touch sensor has detected a release of the first contact and the second touch sensor has detected the second contact within a predetermined time period after the release of the first contact.

4. The image taking device according to claim 2, wherein the operation unit opens and closes the shutter after the second touch sensor has detected the second contact while the first contact is being detected by the first touch sensor.

5. The image taking device according to claim 2, wherein the operation unit opens and closes the shutter after the second touch sensor has detected the release of the second contact and also the second touch sensor has detected the second contact within a predetermined time period after the release of the first contact.

6. The image taking device according to claim 2, wherein upon detecting that the second touch sensor has been touched for at least a predetermined time period, the operation unit opens and closes the shutter at predetermined time intervals until the contact is released.

7. The image taking device according to claim 2, wherein the operation unit opens and closes the shutter when the second touch sensor has detected the second contact.

8. The image taking device according to claim 2, wherein the operation unit opens and closes the shutter when the second touch sensor has detected a release of the second contact.

9. The image taking device according to claim 2, wherein:
the first touch sensor is positioned on a first surface of the housing; and
the second touch sensor is positioned on a second surface of the housing that is different from the first surface.

10. The image taking device according to claim 2, further comprising a touch-sensitive panel provided on the housing, wherein a portion of the touch-sensitive panel functions as at least one of the first and second touch sensors.

11. The image taking device according to claim 10, wherein the portion of the touch-sensitive panel that functions as at least one of the first and second touch sensors is arbitrarily configurable by the user.

12. The image taking device according to claim 2, further comprising a touch-sensitive panel provided on the housing, wherein predetermined areas of the touch-sensitive panel separated by space respectively function as the first and second touch sensors.

13. The image taking device according to claim 12, wherein the predetermined areas of the touch-sensitive panel are arbitrarily configurable by the user.

14. The image taking device according to claim 2, wherein the imaging unit has an auto-focusing function and determines a focal length when the first touch sensor has detected the first contact.

15. The image taking device according to claim 2, wherein the operation unit has a control unit configured to perform fingerprint authentication, and the control unit determines that the first touch sensor has detected the first contact when the control unit determines that fingerprint authentication is successful based on a signal that is output when the first touch sensor has detected the first contact.

16. The image taking device according to claim 2, comprising two first touch sensors, wherein the two first touch sensors are provided at positions separated by space, and the control unit opens and closes the shutter after the two first touch sensors have detected a contact and the second touch sensor has detected the second contact within a predetermined time period after the contact detected by the two first touch sensors.

17. A portable terminal comprising:
the image taking device according to claim 2; and
a data communication function configured to perform data communication by radio.

18. A method for taking an image of a subject by opening and closing a shutter, the method comprising:
detecting a first contact, by a first touch sensor provided on a housing of an image taking device; and
detecting a second contact, by a second touch sensor provided on the housing of the image taking device after the first touch sensor detected the first contact, wherein a control unit in the image taking device opens and closes the shutter after the second touch sensor has detected the second contact.

19. The method according to claim 18, further comprising opening and closing the shutter when the second touch sensor detects the second contact within a predetermined time period after detection of the first contact by the first contact sensor.

20. The method according to claim 18, further comprising opening and closing the shutter after the second touch sensor has detected the second contact with a predetermined time period after release of the first contact.

21. The method according to claim 18, further comprising operating the shutter when the second touch sensor has detected the second contact while the first contact is being detected by the first touch sensor.

22. The method according to claim 18, further comprising operating the shutter when the second touch sensor has detected a release of the second contact within a predetermined time period after release of the first contact.
